(19) United States
(12) Patent Application Publication
(10) Pub. No.: US 2012/0146324 A1
(43) Pub. Date: Jun. 14, 2012

(54) Watertight, Expandible and Contractible Pipe Joint for High Temperature Insulated Piping

(75) Inventor: Thomas Joseph Keyes, Fort Worth, TX (US)

(73) Assignee: Thermacor Process, LP, Fort Worth, TX (US)

(21) Appl. No.: 13/012,510

(22) Filed: Jan. 24, 2011

Related U.S. Application Data
(60) Provisional application No. 61/422,500, filed on Dec. 13, 2010.

(51) Int. Cl. F16L 55/00; B23P 11/00

(52) U.S. Cl. 285/187; 29/428

(57) ABSTRACT

An expansion joint is shown for an insulated pipeline used to convey high temperature fluids such as steam. The expansion joint uses a flexible bellows and additional insulating and joining components to provide a watertight encasement for a traditional metal expansion joint. The bellows arrangement compensates for any relative movement of the inner fluid conveying pipes with respect to the outer layers of insulating material and outer jacket in order to protect the integrity of the assembly and prevent the intrusion of water or other contaminants which could lead to corrosion or early failure of the piping system.

### CROSS-REFERENCE TO RELATED APPLICATION

The present application claims priority from Provisional Application Ser. No. 61/422,500, filed Dec. 13, 2010 by the same inventor.

### BACKGROUND OF THE INVENTION

1. Field of the Invention

The present invention relates to insulated piping systems of the type used to convey high temperature fluids and, more specifically, to an expansion joint for such piping systems which counteracts the tendency of the carrier pipe in these systems to move as the systems thermally expand and contract in the presence of high temperature fluids being conveyed.

2. Description of the Prior Art

There are many instances in which insulated pipelines are needed. For example, distributed HVAC (heating, ventilation and air conditioning) applications utilize chilled water for cooling and steam for heating. The chiller and boiler are typically contained in a central location and the chilled water and steam are distributed to other locations. For example, on a school campus, the chiller and boiler may be located in a power plant building. The chilled water and steam are distributed to classrooms in separate buildings.

A set of insulated pipelines is used to convey the chilled water from the chiller to other locations and back to the chiller. Another set of insulated pipelines is used to carry the steam from the boiler to the other locations and back to the boiler. The insulated pipelines are oftentimes buried underground. In other pipeline installations of the type under consideration, the insulated pipelines may be run through tunnels from one location to another. This type of installation is common, for example around naval shipyards and other military installations.

Insulated pipe which is the subject of this discussion is conventional and commercially available. There are predominately two types of piping systems in use: Class-A drainable dryable testable (DDT); and polyurethane or polyisocyanurate bonded foam systems. While the present application will be described primarily with reference to the bonded foam type system, it will be apparent in the description which follows that the expansion joint of the invention could be installed within a variety of types of pipelines conveying high temperature fluids, including field insulated or even bare pipelines.

With reference now to the “bonded foam” type systems, these systems typically utilize a steel pipe to convey fluid. Around the outside of the steel pipe is a layer of insulating foam such as, for example, polyurethane or polyisocyanurate foam. Around the outside of the foam is a jacket of hard thermoplastic (such as high density polyethylene, HDPE). The plastic jacket protects the foam from mechanical damage and also provides a water tight seal to prevent corrosion of the steel pipe.

The most important engineering criteria for a foam system of the type under consideration is that it must be treated as a bonded system. In other words, the foam is bonded to both the carrier pipe and the outer jacket. Therefore, the bonded system acts as a monolithic unit moving underground. Higher temperatures can act adversely upon the bonded foam system, however. The hot fluid in the steel carrier pipe causes the carrier pipe to thermally expand. At temperatures approaching 400° F. this expansion is on the order of 2.8 inches per 100 feet of pipe. This expansion is not a problem as long as the system remains bonded and the carrier pipe, foam and jacket move together as one unit. This monolithic movement of the system occurs along each incremental length of a particular run, and as long as total movement is not greater than about 4 to 6 inches and the system remains bonded, no undue stress is subjected at any one point of the jacket. In the case of piping installation which are buried underground, if the system were to disbond, the surrounding soil would fix the jacket in place and the carrier pipe would still thermally expand thereby pushing thorough and destroying the jacket at the first change of direction.

Various approaches have been taken to control this undesirable expansion in insulated pipe systems of the type under consideration. One approach is to install “expansion loops” at intervals along the length of the run of piping. Also, in the case of underground piping installations, expansion “bolster” materials are supplied in the form of resilient pads which can be used to wrap the HDPE jacket at elbows or expansion loops.

Expansion joints have also been used in the past to counter the effects of expansion and contraction. Applicant's own prior U.S. Pat. No. 7,143,788, issued Dec. 5, 2006, to Thomas Joseph Keyes, shows an expansion joint in the form of a flexible coupling for an underground insulated piping system of the type used to convey steam and other high temperature fluids. The coupling uses a flexible rubber bellows and additional insulating and joining components to couple conventional lengths of foam bonded pre-insulated piping. The purpose of the bellows is to allow the outer jacket to stretch in the event the surrounding earth load is strong enough that the internal carrier pipe and outer jacket are no longer bonded. In this case, the inner carrier pipe would be expanding while the outer jacket is frozen in place. Upon encountering a change in direction, the bellows would be installed so that the jacket at that one location could stretch enough so that it would not rip apart, since all of the length of jacket leading up to that point would be frozen in place. The bellows arrangement compensates for any relative movement of the inner fluid conveying pipes with respect to the outer layers of insulating material and outer jacket in order to protect the integrity of the assembly and prevent the intrusion of water or other contaminants which could lead to corrosion or early failure of the piping system.

Despite the advance presented by the aforementioned U.S. Pat. No. 7,143,788, there continues to exist a need for an expansion joint or flexible coupling which can be installed and used in congested areas where there is insufficient room for the more traditional approaches (such as an expansion loop). For example, as mentioned briefly above, insulated pipelines of the type under consideration may be routed through tunnels, rather than buried underground. In the past, these tunnel installations would typically be provided with traditional uninsulated metallic expansion joints (such as those manufactured by Hyspan® of Chula Vista Calif., and others) at selected locations along the length of the pipeline. These expansion joints worked acceptably in tunnel locations, except when tunnel flooding occurred. Flood waters reaching the uninsulated metallic expansion bellows caused damage to the hot bellows, usually requiring that the joint be replaced or repaired.

Piping of the type under consideration is also hung under piers and wharfs to feed steam to docked ships. Usually the piping is located in a high enough location to be kept dry, but high seas, hurricane conditions, etc. can cause the pipe to become wet with the same problems being encountered as in the case of flooded tunnels.

From the foregoing it will be appreciated that it would be convenient on many occasions to have a pre-manufactured pipe joint or section with expansion capabilities, which pre-manufactured joint could be incorporated into an insulated pipeline in a confined or congested location, such as a tunnel. For example, the new section of piping might be on the order of 5 to 8 feet in length with its own insulated, watertight expansion capability, whereby the whole jacketed body could move in and out from either end of the 5 to 8 foot section. The outer jacket and surrounding foam insulation would remain bonded. As the piping approaches a steel expansion joint, the outer jacket would be allowed to compress in on itself while the steel inner carrier pipe would continue to move into the expansion joint. Flooding in a tunnel location would no longer be a catastrophic event, since the bellows joint would itself be factory pre-insulated.

Thus, despite the various advances in the art, a need continues to exist for an expansion installation in a piping system for high temperature fluids such as insulated steam line which is pre-made at the factory and which can be installed in simplified fashion in a congested piping location.

### SUMMARY OF THE INVENTION

The present invention has as its general object to provide a pre-manufactured bellows joint for a high temperature line expansion installation which satisfies the previously described deficiencies in the prior art systems.

The watertight, expandible and contractible pipe joint of the invention is intended for use with high temperature insulated piping, such as piping carrying steam or other hot fluids. The pipe joint of the invention includes a first and second length of inner metal carrier pipe, each having an inner end connected to a metallic expansion joint and an opposite, outwardly extending end. The first and second lengths of metal pipe are surrounded by an envelope of bonded foam insulation. The foam insulation, in turn, is surrounded by an outer protective jacket. The outwardly extending end of each of the first and second lengths of metal carrier pipe projects beyond an end of the envelope of insulation and beyond an end of the jacket to form an exposed, joining end. The joining ends of the inner pipes are sealingly connected in a piping string to form a continuous fluid conduit for conveying high temperature fluids.

A flexible tubular bellows, formed of a rubber or rubber-like material, surrounds the inner ends of the inner pipes and the metallic expansion joint in a radially spaced apart fashion and is capable of being axially expanded and contracted. The rubber bellows has opposing outer extents which are joined to the respective synthetic outer protective jackets of the respective first and second lengths of inner metal carrier pipe thereby defining a closed bellows interior.

A layer of high temperature insulation surrounds the inner pipe ends and the metallic expansion joint within the closed bellows interior, whereby the insulation, rubber bellows and outer protective jacket form a water tight encasement for the metallic expansion joint.

In one version, the pipe joint of the invention has a metal end cap welded to each outwardly extending end of each of the inner carrier pipes at a point which encapsulates the layer of high temperature insulation, to thereby provide a water proof end closure and a stand-alone pipe joint which can be installed in a run of bare or field insulated piping.

In another version of the pipe joint of the invention, a metal water stop is welded to at least one of the inner carrier pipes at a predetermined point along the length thereof within the layer of surrounding high temperature insulation. The special watertight, expandible and contractible pipe joint is then installed within a run of bonded foam high temperature insulated piping at one point along the length thereof.

In a particularly preferred form of the invention, the foam insulation is a high temperature polyisocyanurate foam and the protective jackets are formed from a synthetic polyolefin. The rubber tubular bellows is joined, as by electrofusing, at either of the opposite extents thereof to the respective protective jackets of the respective inner carrier pipes. The layer of high temperature insulation surrounding the inner pipe ends and the metallic expansion joint within the closed bellows interior can be any convenient insulating material, such as a layer of high temperature flexible foam.

In the method of using the pipe coupling of the invention, a pipeline is provided comprised of a plurality of lengths of high temperature insulated piping which are joined together in continuous fashion to convey steam or other hot fluids. The watertight, expandible and contractible pipe joint of the invention, as has been described, is installed within the pipeline at a desired location. The metallic expansion joint present within the stand-alone pipe joint of the invention is itself insulated and watertight so that it is isolated from flood waters or other environmental factors.

Additional objects, features and advantages will be apparent in the written description which follows.

### BRIEF DESCRIPTION OF THE DRAWINGS

FIG. 1 is a simplified elevational view of a typical insulated piping installation showing the location of two expansion loops in the piping.

FIG. 2 is a close-up, isolated view of one of the expansion loops of FIG. 1.

FIG. 3 is a side view, partly broken away, of one of the joints of pre-insulated piping used in the installation shown in FIG. 1.

FIG. 4 is a cross sectional view of the pipe joint of FIG. 3, taken along lines IV-IV, with the outer plastic jacket shown in somewhat exaggerated fashion for ease of illustration.

FIG. 5 is a side, partial cross sectional view of one form of the improved watertight expandible and contractible pipe joint of the invention having welded end caps and showing the insulated expansion region thereof.

FIG. 6 is a view of another form of the improved watertight expandible and contractible pipe joint of the invention with a water stop welded to the internal carrier pipe at either of two opposing ends thereof.

### DETAILED DESCRIPTION OF THE INVENTION

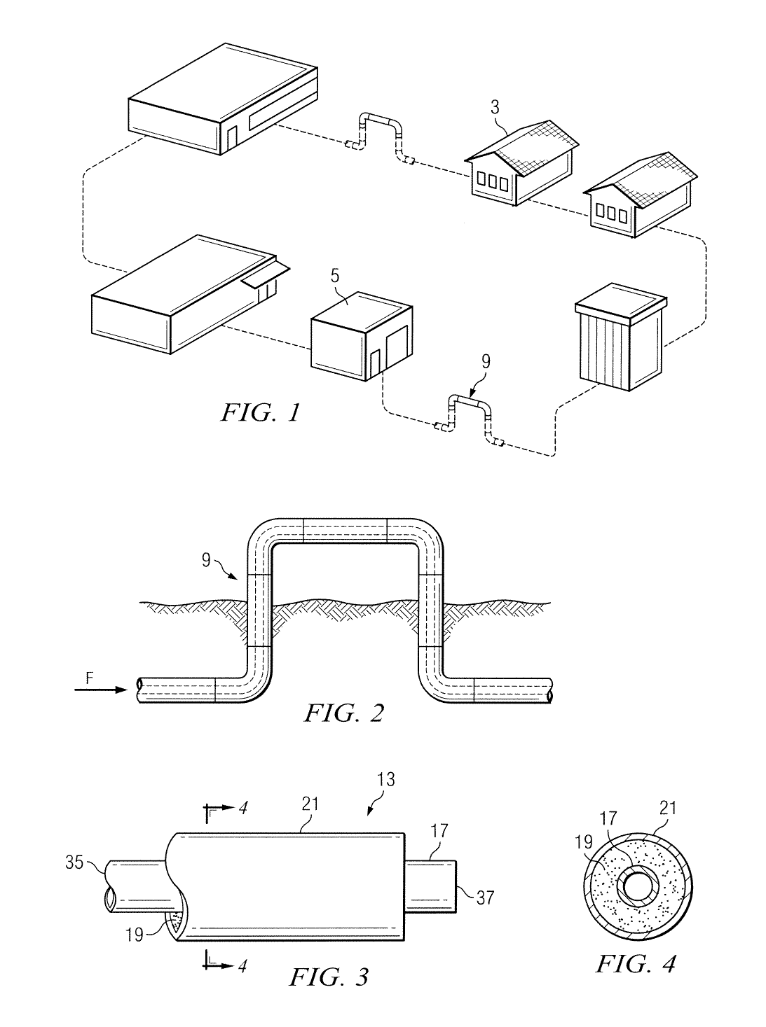

Turning first to FIGS. 1-4, there is shown a typical environment in which a pre-insulated piping system of the type used to convey high temperature fluids might be employed. FIG. 1 shows a school campus having a number of isolated buildings 3, 5, connected by an underground insulated pipeline carrying steam which at points includes right angle loops or elbows 9. FIG. 2 shows one of the expansion loops 9 in greater detail. Loops of this type might be installed at various locations along the run of piping to accommodate expansion and contraction forces in the pipeline caused by, for example, changes in temperature. These types of expansion loops perform well in many situations with underground piping systems. However, they require a certain amount of space to install. In the case of insulated piping systems run through confined spaces, such as for example tunnel installations, there may not be adequate space for expansion loops.

FIGS. 3 and 4 show a typical joint of bonded foam pre-insulated piping of the type which might be used in the piping installation of FIG. 1. The installation shown in FIG. 1 includes a number of such coaxially oriented lengths of pipe, such as length 13 (shown broken away in FIG. 3). Each length of pipe includes an inner pipe 17, typically formed of steel, an envelope of foamed insulation 19 surrounding the inner pipe and outer protective jacket 21 surrounding the envelope of insulation. The outer jacket 21 is shown in somewhat exaggerated fashion in FIG. 4 for purposes of illustration, but would normally be only a few millimeters in thickness. The joining ends (shown generally as 35, 37 in FIG. 7) of adjacent pipe lengths are affixed, as by being welded together, to form fixed joints, whereby the adjacent pipe lengths provide a continuous fluid conduit for conveying high temperature fluids. The jacket 21 (FIG. 1) is typically formed of high density polyethylene (HDPE) or a similar polyolefin type material. The following references, among others, teach the manufacture of such prior art systems: U.S. Pat. No. 3,793,411; U.S. Pat. No. 4,084,842; and U.S. Pat. No. 4,221,405, all to Stonitsch et al.

The piping systems of the type illustrated in FIGS. 3 and 4 are sometimes utilized to convey fluids at high temperature and/or pressures. For example, a typical steam line might be conveying fluid at temperatures up to, for example, 400° F. The temperature differentials which exists between the piping system materials and the fluid being conveyed can cause a force (“F” in FIG. 2) to be applied along the coaxially aligned pipes lengths. If the carrier is free to move independently from the foam and jacket (disbondment has occurred) then the surrounding soil will fix the jacket in place and the carrier pipe will burst through the foam and jacket.

In the piping system illustrated in FIG. 1, the system is displacing as a unit due to the presence of the expansion loops. Movement in the system does not damage the jacketing or the foam of the system because they are both incrementally being pulled along throughout the entire length of the straight run. Because of this monolithic movement no one individual section of the jacket is over stressed and thereby ruptured, and no one individual section of the foam is required to support the entire force of the thermal expansion of the pipe. The bond distributes these forces along each incremental length of the entire run. It will be understood, however, that should the forces become great enough, disbondment of the foam from the carrier pipe can occur. In such case, the foam and outer jacket can be ruptured. Failure of the surrounding insulated layers allows water or other contaminants to contact the steel pipe, leading to increased corrosion and joint failure in some cases.

As has been briefly discussed, Applicant's prior U.S. Pat. No. 7,143,788, issued Dec. 5, 2006, to Thomas Joseph Keyes, was an attempt to address the problem of piping systems where disbondment of the foam layer and outer jacket had occurred. In that patent, a bellows is used to compensate for the movement of the inner carrier pipe relative to the outer foam insulation and jacket to allow the outer jacket to stretch in the event the surrounding earth load is strong enough that the internal carrier pipe and outer jacket are no longer bonded. The bellows allows the jacket to stretch enough so that it will not rip apart, since all of the length of jacket leading up to that point would be frozen in place.

In the present invention, the outer jacket and foam insulation remain bonded. As the piping approaches a steel expansion joint, the jacket is allowed to compress in on itself while the inner steel carrier pipe continues to move into the expansion joint. That is, the outer jacket is allowed to compress on itself, while the carrier pipe is able to compress into the expansion joint. This construction also allows the steel expansion joint to be sealed water tight, whereas the prior art bonded pipe/foam/jacket systems had to be terminated with the steel expansion joint simply being field insulated. Field insulation is not watertight.

In one aspect, the present invention is directed toward an expansion installation for high temperature insulated piping systems of the type illustrated generally in FIGS. 1-4. The present invention is intended to provide a solution to prevent possible disbondment problems of such bonded foam piping systems that are operating at temperatures in the range of 250° F. and above 250° F. The invention is intended to prevent the potential problems that might occur if the foam bond strength is not sufficient to cause the system to expand as one monolithic item.

While the discussion which follows will center primarily around a description of such “bonded foam” pre-insulated piping systems, it will be understood by those skilled in the relevant arts that the improved expansion joint of the invention might be used with other types of piping systems, as well. For example, the run of piping might be field insulated piping, or even conceivably bare pipe.

The reference in this discussion to “bonded foam” piping is intended to refer to standard available factory pre-insulated piping of the type previously described having an inner metal pipe surrounded by an envelope of foamed insulation, which in turn, is contained within a polyolefin jacket. As referred to briefly above, typical commercial practice involves the use of steel, copper, aluminum or alloy conveying pipes, open or closed cell polyurethane, polyisocyanurate, polystyrene or the like, foamed rigid insulation and polypropylene, polybutylene, polyethylene, polyvinylchloride and similar protective jackets.

Prior art pipe lengths of pre-insulated bonded foam are commercially available as standard factory type product. For example, such product is available from Thermacor Process, LP of Fort Worth, Tex., assignee of the present invention. One typical example is sold commercially as the HT-406 High Temp Steel Piping System. The published specifications for systems are as follows:

### Carrier Pipe—

| diameter less than about 2″ | A53 ERW Grade B, Std. Wt. | |
|---|---|---|
| | Black Steel | |
| diameter greater than about 2″ | A106 SML, Std. Wt. Black Steel | |
| HDPE Jacket- | | |
| Compatible with ASTM D3350 | | |
| Specific Gravity (ASTM D792) | 0.941 | min. |
| Tensile Strength (ASTM D638) | 3100 | psi min. |
| Elongation Ultimate (ASTM D638) | 400% | min. |
| Compressive Strength (ASTM D695) | 2700 | psi min. |
| Impact Strength (ASTM D256) | 2.0 ft. lb/in. North Min. | |
| Rockwell Hardness (ASTM D785) | D60 (Shore) min. | |
| Polyisocyanurate Insulation- | >2.4 | lbs/ft³ |
| Density | | |
| “K” Factor | ≦0.14 @ 70° F., ≦0.24 | |
| | @ 406° F. | |
| Compressive Strength | >30 | psi |

| | |
|---|---|
| Closed Cell Content | ≧90% |
| Minimum Thickness | ≧2.5″ @ 366° F., ≧3.0″ |
| | @ 406° F. |

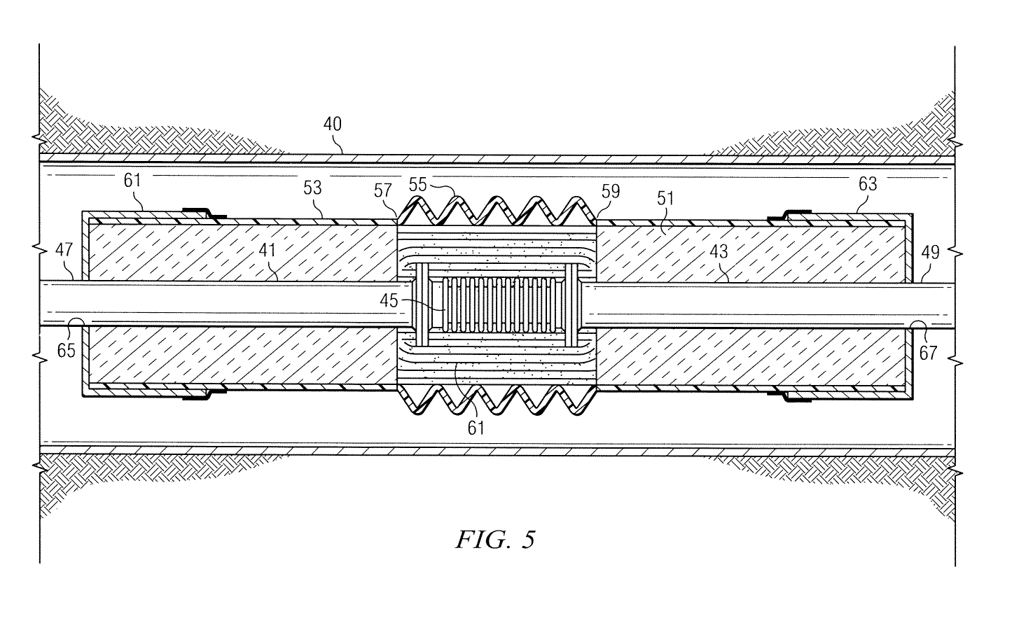

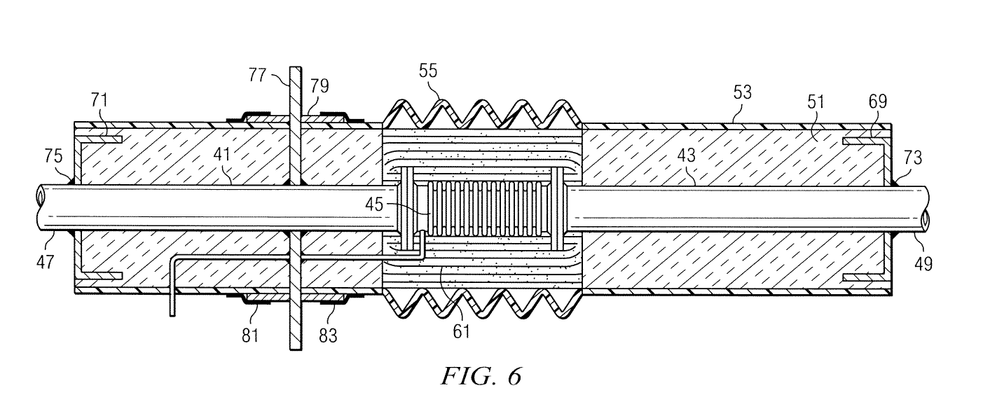

The present invention is directed toward a flexible, extendible and contractible pipe joint for use in high temperature insulated piping systems of the type illustrated generally in FIG. 1. The expansion joint of the invention is intended to alleviate the damage which might occur by expansion and contraction forces acting on the pipeline, as discussed above. Also, rather than being buried in the ground, as shown in FIG. 1, the insulated piping might be run through tunnels or other passageways, as shown in FIGS. 5 and 6.

The improved expansion joint of the invention is designated generally as 39 in FIG. 5. The expansion joint 39 is shown located within a surrounding tunnel casing 40 located in a subterranean location. The watertight, expandible and contractible pipe joint includes a first and second length 41,43, of inner metal carrier pipe, each having an inner end connected to a metallic expansion joint 45 and an opposite, outwardly extending end (shown at 47, 49 in FIG. 5). The metallic expansion joint 45 is a metallic bellows having a corrugated outer configuration which allows expansion and contraction of the inner carrier pipes 41, 43, in the conventional manner. The first and second lengths of metal carrier pipe are surrounded by an envelope of bonded foam insulation 51, the foam insulation, in turn, being surrounded by an outer protective jacket 53. As shown in FIG. 5, the outwardly extending end 47, 49, of each of the first and second lengths of metal carrier pipe projects beyond an end of the envelope of insulation and beyond an end of the jacket to form an exposed, joining end for the pipe joint. The joining ends of the inner pipes are sealingly connected in a piping string, as by welding, to form a continuous fluid conduit for conveying high temperature fluids.

In order to accommodate expansion and contraction forces in the pipeline, the previously mentioned metallic expansion joint is used to join the inner ends of the carrier pipes 41, 43. The metallic expansion joint can be any of a number of commercially available metallic expansion joints, such as those sold by Hyspan® of Chula Vista, Calif. A flexible tubular bellows 55 also surrounds but is spaced radially apart from the inner ends of the inner pipes 41, 43, and the metallic expansion joint 45. The bellows is typically formed of a suitable rubber or rubber-like material. The bellows forms an outer watertight sleeve about the metallic expansion joint and is also capable of being axially expanded and contracted. As will be appreciated from FIG. 5, the tubular bellows has opposing outer extents 57, 59, which are joined to the respective outer protective jackets 53 of the respective first and second lengths of inner metal carrier pipe 41, 43, thereby defining a closed bellows interior. The bellows allows the carrier pipe and associated foam and jacket to push into the Hyspan® type expansion joint while, at the same time, allowing the expansion joint to be insulated and watertight.

The joining of the outer extents 57, 59, of the flexible bellows to the outer jacket material 40 can be accomplished in a number of ways. For example, a commercially available POWERCORE™ welding wire can be used. The outer extents of the bellows is arranged to surround the jacket material and a set of resistive wires. Upon applying an electric current to the wires, a weld between the bellows and jacket is achieved. This type of welding operation is known in the relevant industry.

As shown in FIG. 5, a layer of high temperature insulation 61 surrounds the inner pipe ends and the metallic expansion joint 45 within the closed bellows interior. The high temperature insulation can be any suitable insulation capable of withstanding the expected temperatures present in the pipeline. For example, the insulation might be a mineral wool/calcium silicate. Preferably, the insulation 61 is a commercially available high temperature Flex-Foam™ material. In this way, the insulation, bellows and outer protective jacket form a water tight encasement for the traditional metallic expansion joint.

In the version of the expansion joint of the invention illustrated in FIG. 5, a metal end cap 61, 63, is welded to each outwardly extending end 65, 67, of each of the inner carrier pipes at a point which encapsulates the layer of high temperature insulation 51, to thereby provide a water proof end closure and a stand-alone pipe joint. Because the expansion joint shown in FIG. 5 is completely encased and watertight as provided from the factory, it can be installed in a run of bare or field insulated piping. This would be accomplished, as by welding the inner carrier pipe ends 47, 49, into the run of piping making up the fluid conduit for transporting high temperature fluids.

In the version of the expansion joint illustrated in FIG. 6, the joint again has the same general makeup of metallic expansion joint 45, inner carrier pipes 41, 43, surrounding high temperature foam insulation 51 and outer protective jacket 53. In this case, the joint illustrated would be intended to be included in a run of pre-insulated piping such as the section of piping illustrated in FIGS. 3 and 4. The particular expansion joint illustrated in FIG. 6 has a metal water stop 69, 71, welded to each of the carrier pipes at a predetermined point 73, 75, along the length thereof within the layer of surrounding high temperature insulation 51. The expansion joint illustrated in FIG. 6 also has an anchor plate welded to one of the inner carrier pipes 41 and an outer metal sleeve 79. The outer metal sleeve is attached to the outer protective jacket 53, as by heat shrink materials 81, 83. The heat shrink materials might be, for example, electrofused at either of the opposite extents of the metal sleeve 79 to the respective protective jackets of the respective inner carrier pipes.

Unlike the stand-alone joint of FIG. 5, the joint of FIG. 6 would typically be installed within a run of pre-insulated piping as by welding the carrier pipe ends 47, 49, within the piping run. The juncture point of the exposed ends 47, 49, would then be insulated in conventional manner, making the inner high temperature foam layer 51 be continuously insulated along the length of the piping run. For example, the joining ends might be covered with a layer of polyurethane foam for systems under 250° F. or a polyisocyanate foam for systems above 250° F. In some cases, it is possible to place a hollow jacket about the pipe joining ends 47, 49, with a two part commercially available mix being added through a hole in the jacket and allowed to cure. In another method of insulating the pipe joining ends, the insulating layer for the joining ends of the pipe is preformed at the factory and provided as two side half cuts which are placed about the pipe joining ends to form a concentric cylinder. Further details of the installation and operation of the anchor plate 77 and water stops 69, 71, are detailed in Applicant's copending application Ser. No. 12/456,664, filed Jun. 19, 2009, by Thomas Joseph Keyes, entitled “Anchor System For Pre-insulated Piping”; and Ser. No. 12/701,172, filed Feb. 5, 2010, by Thomas Joseph Keyes, entitled “Water Spread Limiting System For Pre-insulated Piping.”

The previously described expansion joints can be used in a method of coupling lengths of insulated piping used to form a high temperature fluid conveyance system. The method comprising the steps of:

providing a pipeline comprised of a plurality of lengths of high temperature insulated piping which are joined together in continuous fashion;
installing a stand-alone watertight, expandible and contractible pipe joint within the pipeline at a desired location, the expandible and contractible pipe joint comprising:
a first and second length of inner metal carrier pipe, each having an inner end connected to a metallic expansion joint and an opposite, outwardly extending end, the first and second lengths of metal pipe being surrounded by an envelope of foam insulation, the foam insulation, in turn, being surrounded by an outer protective jacket, and wherein the outwardly extending end of each of the first and second lengths of metal carrier pipe projects beyond an end of the envelope of insulation and beyond an end of the jacket to form an exposed, joining end, the joining ends of the inner pipes being sealingly connected in the piping string which forms a continuous fluid conduit for conveying high temperature fluids;
a flexible tubular bellows surrounding the inner ends of the inner pipes and the metallic expansion joint, the bellows being capable of being axially expanded and contracted, the tubular bellows having opposing outer extents which are joined to the respective outer protective jackets of the respective first and second lengths of inner metal carrier pipe thereby defining a closed and watertight bellows interior; and
a layer of high temperature insulation surrounding the inner pipe ends and the metallic expansion joint within the closed bellows interior, whereby the insulation, bellows and outer protective jacket form a water tight encasement for the metallic expansion joint.

The same method can be used with the expansion joint illustrated as FIG. 6 in the drawings and described in detail above.

It should be understood by those skilled in the art that, while the invention has been described with reference to the preferred “flexible bellows” as the mechanism used to provide jacket flexibility, that other devices or constructions might be used, as well to provide the needed flexibility. Some flexible sheet materials might have the needed expansion or stretching ability inherent in the material itself, without requiring the presence of corrugations or wrinkles in the material. The critical aspect is that the mechanism be a “plastic” or other flexible type material which provides the needed flexibility and which is able to be fused or securely attached to the adjacent jacketing of the insulated pipeline, while providing watertight insulation for the expansion joint.

An invention has been provided with several advantages. The watertight encasement for a bellows joint of the invention can be provided as a stand-alone joint which can be installed in a variety of types of fluid piping systems of the type used to convey high temperature fluids. The flexible expansion and contraction characteristics of the pipe joint of the invention alleviates many of the problems previously encountered with high temperature piping systems where changes in temperature and other factors caused movement in the pipeline, subjecting sections of the piping to damaging stresses. The system incorporates several existing, commercially available materials or components, thereby simplifying manufacture and assembly. The particular bellows and additional flexible coupling components of the system compensate for relative movement of the inner steel pipe which could disrupt the continuity of the surrounding insulating layer in the case of pre-insulated piping systems. The coupling is simple in design and economical to implement in a variety of industrial applications.

While the invention has been shown in only two its forms, it is not thus limited but is susceptible to various changes and modifications without departing from the spirit thereof.

What is claimed is:

1. A watertight, expandible and contractible pipe joint for high temperature insulated piping, the pipe joint comprising:
a first and second length of inner metal carrier pipe, each having an inner end connected to a metallic expansion joint and an opposite, outwardly extending end, the first and second lengths of metal pipe being surrounded by an envelope of bonded foam insulation, the foam insulation, in turn, being surrounded by an outer protective jacket, and wherein the outwardly extending end of each of the first and second lengths of metal carrier pipe projects beyond an end of the envelope of insulation and beyond an end of the jacket to form an exposed, joining end, the joining ends of the inner pipes being sealingly connected in a piping string to form a continuous fluid conduit for conveying high temperature fluids;
a flexible sheet material surrounding but spaced radially apart from the inner ends of the inner pipes and the metallic expansion joint, the sheet material being capable of being axially expanded and contracted, the sheet material having opposing outer extents which are joined to the respective outer protective jackets of the respective first and second lengths of inner metal carrier pipe thereby defining a closed and watertight bellows interior; and
a layer of high temperature insulation surrounding the inner pipe ends and the metallic expansion joint within the closed bellows interior;
the insulation, flexible sheet material and outer protective jacket forming a water tight encasement for the metallic expansion joint, the flexible sheet material being compressible on itself while allowing the inner carrier pipe to compress the metallic expansion joint.

2. The watertight, expandible and contractible pipe joint for high temperature insulated piping of claim 1, wherein a metal end cap is welded to each outwardly extending end of each of the inner carrier pipes at a point which encapsulates the layer of high temperature insulation, to thereby provide a water proof end closure and a stand alone pipe joint which can be installed in a run of bare or field insulated piping.

3. The watertight, expandible and contractible pipe joint for high temperature insulated piping of claim 1, wherein a metal water stop is welded to each of the carrier pipes at a predetermined point along the length thereof within the layer of surrounding high temperature insulation.

4. The watertight, expandible and contractible pipe joint for high temperature insulated piping of claim 1, wherein the foam insulation is selected from the group consisting of polyurethane foams and polyisocyanurate foam.

5. The watertight, expandible and contractible pipe joint for high temperature insulated piping of claim 1, wherein the protective jackets are formed from a synthetic polyolefin.

6. The watertight, expandible and contractible pipe joint for high temperature insulated piping of claim 1, wherein the flexible sheet material takes the form of a tubular bellows, and wherein the tubular bellows is electrofused at either of the opposite extents thereof to the respective protective jackets of the respective inner carrier pipes.

7. The watertight, expandible and contractible pipe joint for high temperature insulated piping of claim 1, wherein the lengths of insulated piping being joined are part of a pipeline conveying steam, hot water or other hot fluids.

8. The watertight, expandible and contractible pipe joint for high temperature insulated piping of claim 6, wherein the layer of high temperature insulation surrounding the inner pipe ends and the metallic expansion joint within the closed bellows interior is a layer of high temperature flexible foam.

9. The watertight, expandible and contractible pipe joint for high temperature insulated piping of claim 1, wherein the insulated piping is run through a tunnel which is exposed to flood intrusion.

10. A method of coupling lengths of insulated piping used to form a high temperature fluid conveyance system, the method comprising the steps of:
providing a pipeline comprised of a plurality of lengths of high temperature insulated piping which are joined together in continuous fashion;
installing a stand-alone watertight, expandible and contractible pipe joint within the pipeline at a desired location, the expandible and contractible pipe joint comprising:
a first and second length of inner metal carrier pipe, each having an inner end connected to a metallic expansion joint and an opposite, outwardly extending end, the first and second lengths of metal pipe being surrounded by an envelope of foam insulation, the foam insulation, in turn, being surrounded by an outer protective jacket, and wherein the outwardly extending end of each of the first and second lengths of metal carrier pipe projects beyond an end of the envelope of insulation and beyond an end of the jacket to form an exposed, joining end, the joining ends of the inner pipes being sealingly connected in the piping string which forms a continuous fluid conduit for conveying high temperature fluids;
a flexible rubber bellows surrounding the inner ends of the inner pipes and the metallic expansion joint, the bellows being capable of being axially expanded and contracted, the flexible bellows having opposing outer extents which are joined to the respective outer protective jackets of the respective first and second lengths of inner metal carrier pipe thereby defining a closed and watertight bellows interior; and
a layer of high temperature insulation surrounding the inner pipe ends and the metallic expansion joint within the closed bellows interior, whereby the insulation, bellows and outer protective jacket form a water tight encasement for the metallic expansion joint.

11. The method of claim 10, wherein each of the lengths of high temperature insulated piping in the pipeline also comprises a metal inner carrier pipe surrounded by a layer of bonded foam insulation which, in turn, is surrounded by an outer protective jacket.

12. The method of claim 11, wherein the foam insulation which is used to surround the inner pipes is selected from the group consisting of polyurethane foam and polyisocyanurate foam.

13. The method of claim 12, wherein the protective jackets are formed of HDPE.

14. The method of claim 11, wherein the tubular bellows is electrofused at either of the opposite extents thereof to the respective protective jackets of the respective pipe lengths.

15. The method of claim 10, wherein the lengths of insulated piping being joined are part of a pipeline conveying steam at a temperature of 250° F., or greater.
